(19) United States
(12) Patent Application Publication
(10) Pub. No.: US 2009/0237825 A1
(43) Pub. Date: Sep. 24, 2009

(54) STORAGE DEVICE AND CONTROL METHOD THEREOF

(75) Inventors: Noriyuki Sato, Kawasaki (JP); Hideaki Tanaka, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/402,173

(22) Filed: Mar. 11, 2009

(30) Foreign Application Priority Data
Mar. 21, 2008 (JP) 2008-073269

(51) Int. Cl. G11B 20/10

(52) U.S. Cl. 360/39; G9B/20.009

(57) ABSTRACT

A storage device includes an access counter that counts the number of track changes or the number of accessed sectors in accessing the recording medium, an access judgment unit that judges whether the recording medium is accessed successively by a host,
a count judgment unit that judges whether the count counted by the access counter has reached a predefined number of times when the access judgment unit judges that the recording medium is accessed successively, and an access delay unit. The access delay unit delays the access to the recording medium so that a transfer rate between the storage device and the host is adjusted to a predefined transfer rate when the count judgment unit judges that the number of the count has reached the predefined number of times.

### CROSS-REFERENCE TO RELATED APPLICATIONS

This application is based upon and claims the benefit of priority of prior Japanese Patent Application No. 2008-73269, filed on Mar. 21, 2008, the entire contents of which are incorporated herein by reference.

### FIELD

The embodiments discussed herein are related to a storage device that controls a data transfer rate between the storage device and a host computer, and a control method thereof.

### BACKGROUND

Computer systems may use magnetic disk devices with different transfer rates between the storage device and a host. If the transfer rates are different depending on the magnetic device, performances of the magnetic disk devices measured by a performance measurement tool are different. In such case, which performance is applied may be undetermined.

Generally, the following methods are applied when magnetic disk devices with different transfer rates are used:
1. The variation of the transfer rates is not considered, and the apparatus is shipped without adjusting the variation of the transfer rates.
2. The magnetic disk devices are screened based on a certain range of performance before shipping.
3. The performances of the magnetic disk devices are adjusted by increasing a value of a skew.

With method 1 described above, the differential of the performances affects the host to which the magnetic disk devices are connected, and the magnetic disk device with a lower performance can be an impediment. Method 2 may adjust for the variation of the performances. However, the screening before shipping takes time, and therefore a workload increases. Method 3 may adjust for the variation of the performances. However, the performance may be decreased when a head accesses an area with the increased skew randomly.

### SUMMARY

According to an aspect of the embodiment, a storage device includes an access counter that counts the number of track changes or the number of accessed sectors in accessing the recording medium, an access judgment unit that judges whether the recording medium is accessed successively by a host, a count judgment unit that judges whether the count counted by the access counter has reached a predefined number of times when the access judgment unit judges that the recording medium is accessed successively, and an access delay unit. The access delay unit delays access to the recording medium so that a transfer rate between the storage device and the host is adjusted to a predefined transfer rate when the count judgment unit judges that the number of the count has reached the predefined number of times.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 illustrates an example of a structure of the magnetic disk device;

FIG. 2 is an example of a function block diagram of HDD 1 according to an embodiment;

FIGS. 3A and 3B are explanatory drawings for determining a reference value of the number of track changes used for magnetic disk devices (drives A and B);

FIG. 4 is a flow chart illustrating an example of a process executed by HDD 1;

FIGS. 5A and 5B are explanatory drawings of a delay process executed by HDD 1;

FIG. 6 illustrates an example of a storage area divided into blocks;

FIG. 7 is an explanatory drawing for a method delaying only accesses to outer tracks of HDD 1;

FIG. 8 is an example of a function block diagram of HDD 30;

FIG. 9 is an explanatory drawing of a process when HDD 30 receives a command for writing;

FIG. 10 is a flowchart of an example of a writing process executed by HDD 30;

FIG. 11 is an explanatory drawing when HDD 30 receives a command for reading; and

FIG. 12 is a flow chart of an example of a reading process executed by HDD 30.

### DESCRIPTION OF EMBODIMENTS

Preferred embodiments of the present invention will be explained with reference to accompanying drawings.

The embodiments of the present technique will be described with reference to the accompanying drawings. The magnetic disk device will be disclosed as an example of the storage device in these embodiments. However, the storage device is not considered to be limited to the exact construction and applications illustrated and described below.

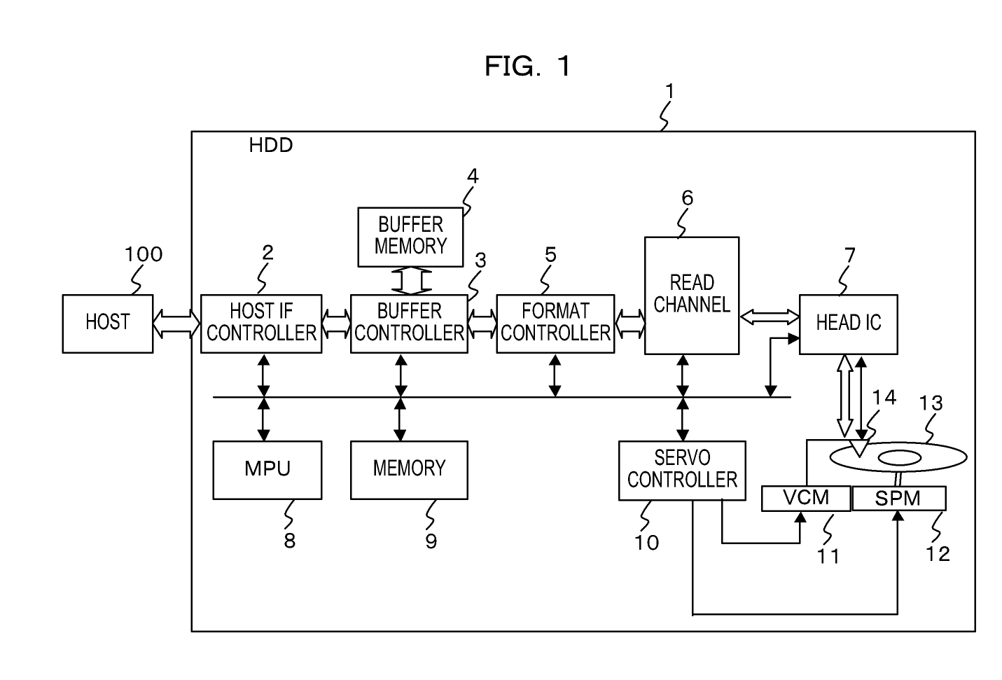

FIG. 1 is the block diagram illustrating the magnetic disk drive called an HDD according to the first embodiment. HDD 1 includes: host interface controller for controlling HDD 1, a host interface for performing data communication and control communication between HDD 1 and host 100, and interface protocol; buffer controller 3 for controlling buffer memory 4 that is a temporary storage area for compensating for a differential between transfer rates between HDD 1 and host 100; and format controller 5 for controlling disk format. In the first embodiment, host 100 is a computer connected with HDD 1. However, host 100 may be another device that is connectable to the storage device such as a DVD recorder including an internal storage device.

Additionally, HDD 1 includes: MPU 8 for controlling read channel 6 later described, servo controller 10, memory 9 including a random access memory (RAM) and a flash read-only memory (ROM); micro processing unit (MPU) 8 for managing memory 9 including a random access memory (RAM) and a read-only memory (ROM); read channel 6 for controlling writing data (i.e., modulating data) onto or reading data (i.e., demodulating data) from magnetic disk medium 13 by head IC 7 and magnetic head 14; and servo controller 10 for controlling voice coil motor (VCM) 11 and spindle motor (SPM) 12. VCM 11 and SPM 12 will be described later.

Moreover, HDD 1 includes: VCM unit 11 for controlling motion of an actuator that supports head 14; and magnetic disk medium 13 for storing data written thereon; and SPM unit 17 for controlling spins of a spindle that supports magnetic disk medium 13.

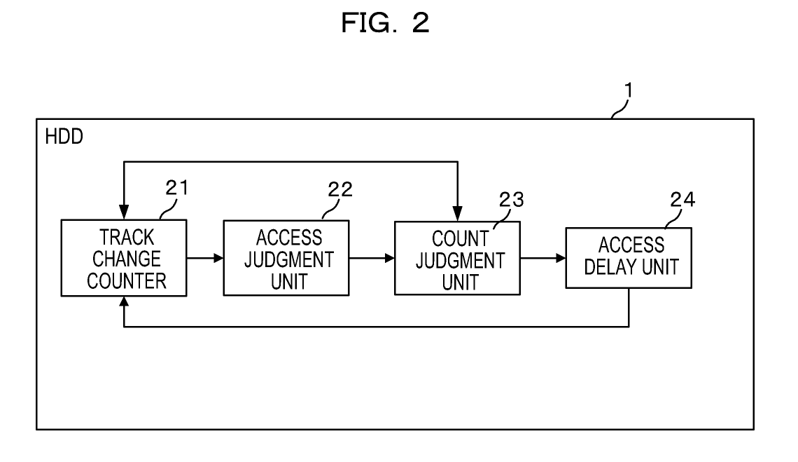

FIG. 2 is the function block diagram of HDD 1 according to the first embodiment. HDD 1 includes track change counter 21, access judgment unit 22, count judgment unit 23 and access delay unit 24. These functions are implemented by hardware described above, which are controlled by executing firmware stored in memory 9 by MPU 8.

Track change counter 21 count how many times head 14 changes tracks in accessing the magnetic disk medium 13 mounted in HDD 1, i.e., in a sequence of reading processes or writing processes. The sequence of reading processes is a sequence of processes to receive all data to be obtained from HDD 1 by host 100. The sequence of the writing processes is a sequence of processes to receive all data to be written on HDD 1 from host 100. The number of track changes is counted under a control of servo controller 10. A value of the count stored in memory 9 is updated in increments of 1 or reset to zero by MPU 8.

Access judgment unit 22 judges whether magnetic disk medium 13 is accessed successively. MPU 8 judges whether magnetic disk medium 13 has been accessed successively based on a control of host interface 2, or by judging whether data are stored in buffer memory 4, or by an operation status of read channel 6.

When access judgment unit 22 judges that the recording medium has been accessed successively, count judgment unit 23 judges whether the count counted by track change counter 21 has reached a reference value (i.e., a predefined number of times). The reference value is derived with a method later described and is stored in memory 9. MPU 8 compares the reference value and the count to judge whether the count has reached the reference value.

When count judgment unit 23 judges that the count reaches the reference value, access delay unit 24 delays an access to the recording medium by using a method later described to adjust a transfer rate to the predefined transfer rate.

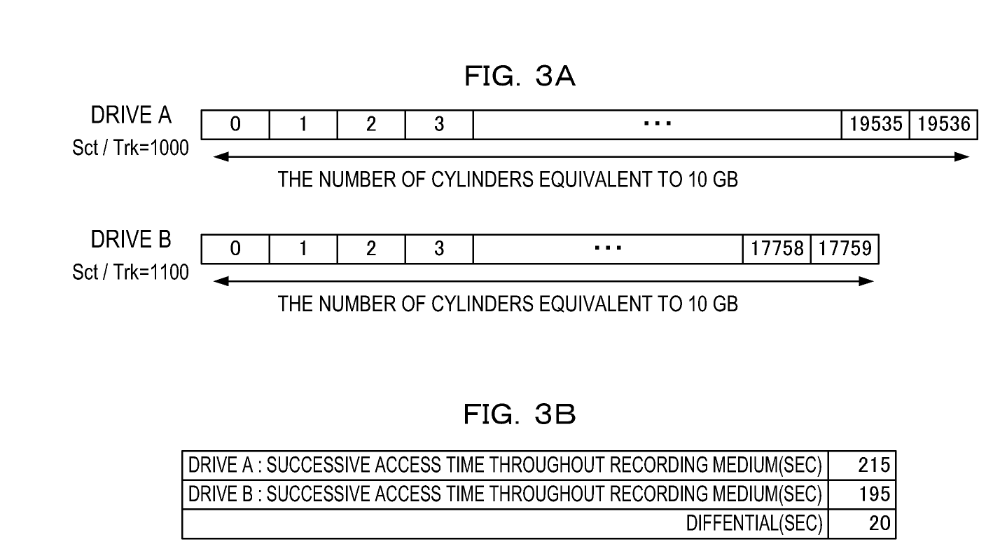

A method for determining the reference value of the number of track changes will be described with reference to FIGS. 3A and 3B.

Ten (10) gigabytes (equivalent to 19,535,040 sectors) of drives A and B, which rotate a recording medium at 5,400 rpm (11.111 ms per revolution) are connected to host 100. Drives A and B are equivalent to HDD 1 described above. For drive A, the number of sectors per track (hereinafter referred to as Sct/Trk) is 1,000 as illustrated in FIG. 3A. For drive B, the number of Sct/Trk is 1,100.

Drive A, with a lower transfer rate, is defined as a reference drive for determining the reference value. A transfer rate of drive B is approximated to a transfer rate of drive A in the first embodiment.

FIG. 3B illustrates processing times of drives A and B. As FIG. 3B illustrates, the time needed for access throughout a storage area of magnetic disk medium 13 mounted in drive A successively is 215 seconds. Whereas, the time needed to access throughout a storage area of magnetic disk medium 13 mounted in drive B is 195 sec. In brief, drive B processes data 20 sec faster than drive A. Thus, performances of drive A and drive B are different by 10%, as well as by a ratio of Sct/Trk. Basically, Sct/Trk decreases as the track nears the center of magnetic disk medium 13 or the spindle. For convenience, Sct/Trk of all the tracks are considered the same.

To adjust the differential between the performances of drives A and B, additional time per track is derived by the following equation and a frequency of adding a rotational delay (i.e., seek time) is derived based on the additional time. In other words, the transfer rate is adjusted by adding the rotational delay according to the frequency of changing a track when data are written on or read from magnetic disk medium 13 successively.

For drive B,

where the additional time per track is ΔT,

ΔT=20 sec×1,000 ms÷17,759=1.1 ms

The number of cylinders for the rotational delay is given by

the number of cylinders=rotational delay (11.111 ms)÷ΔT (1.1 ms)=10 cylinders

Where a byte count per sector is 512 bytes, the transfer rate (MB/s) between drive A and host 100 is given by 1,000×512 bytes÷0.0111 sec=46,126,126 byte/s=46.1 MB/s The transfer rate (MB/s) between drive B and host 100 is given by 1,100×512 bytes÷0.0111 sec=50,738,738 byte/s=50.7 MB/s

Where the rotational delay is added by 10 cylinders, the transfer rate of drive B is given by

1,100×512 bytes÷(0.0111 sec+0.0011 sec)=46,163,934 byte/s=46.1 MB/s

By adding 11.111 ms of rotational delay by 10 cylinders, the performance becomes equivalent to a performance with an added 1.1 ms of rotational delay per cylinder as a whole. In other words, the differential of the performances (i.e., a differential of the transfer rates) between drive A and drive B are reduced by adding the rotational delay after writing data or reading data equivalent to 10 cylinders (i.e., the reference value.)

As a result of the calculation described above, the value of the count, 10, is preconfigured in memory 9 as the reference value. The reference value stored in drive B is derived based on the differential between the time needed for accessing throughout the storage area of magnetic disk medium 13 mounted in drive B and the time needed for accessing throughout the storage area of magnetic disk medium 13 mounted in reference drive A as described above.

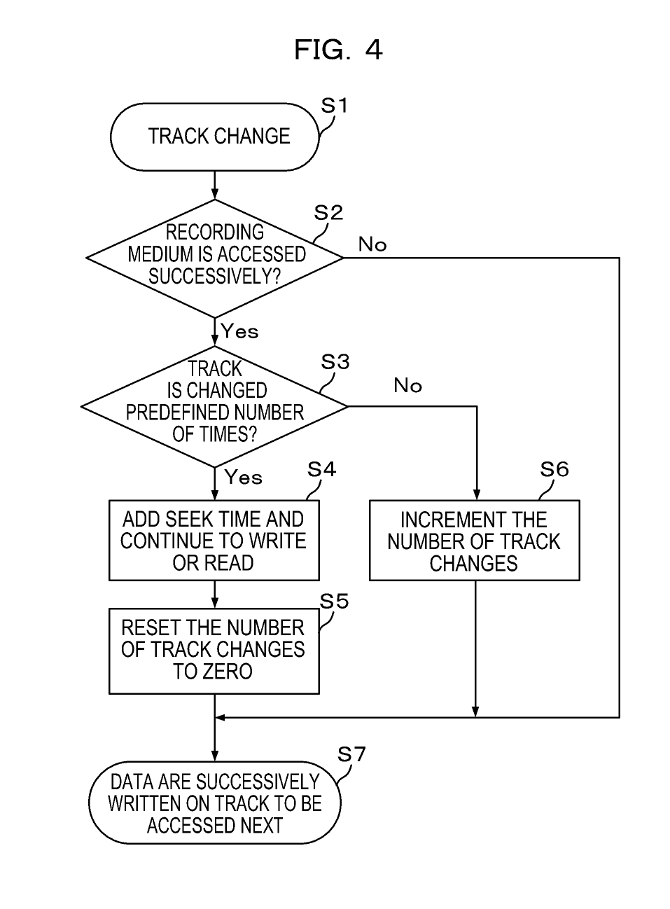

The process executed by HDD 1 according to the first embodiment will be described with reference to the flow chart illustrated in FIG. 4. Here, a case in which a sequence of processes for transferring data in a unit of file, the unit is given by an operating system (OS) of host 100, between host 100 and magnetic disk medium 13 mounted in HDD 1 will be described. The sequence of the processes will be referred to as a write process or a read process (largely, referred to as an access) as necessary.

When the head is moved from one track to another track in step S1, access judgment unit 32 judges whether data are written or read successively in step S2. If the data are written or read successively (step S2, Yes), count judgment unit 33 judges whether the number of track changes has reached the predefined number of times (for example, the case described above, the reference value, 10) in step S3. The number of track changes is counted by track change counter 21 from when the successive writing currently executed is started.

When count judgment unit 33 judges that the number of track changes has reached the predefined number of times (step S2, Yes), access delay unit 24 rotates magnetic disk medium 13 one revolution (i.e., rotates at idle) by adding the rotational delay, and then continues to write or read data from where the writing or reading was interrupted in step S4. As described above, access delay unit 24 slows the transfer rate to a reference transfer rate approximated to the reference transfer rate (i.e., the predefined transfer rate) by adding the seek time to the processing time for the access (i.e., the successive writing or reading).

Then track change counter 21 resets the number of track changes to zero in step S5. The data are successively written on or read from a track to be accessed next in step S7.

If the data are not written or read successively (step S2, No), the process moves on to step S7. If the number of track changes does not reach the predefined number (step S3, No), track change counter 21 adds the number of track changes in increments of 1 in step S6. Then the process moves on to step S7.

The processes in steps S1 through S7 are repeated until all the data needed to be written or read successively by host 100 are processed.

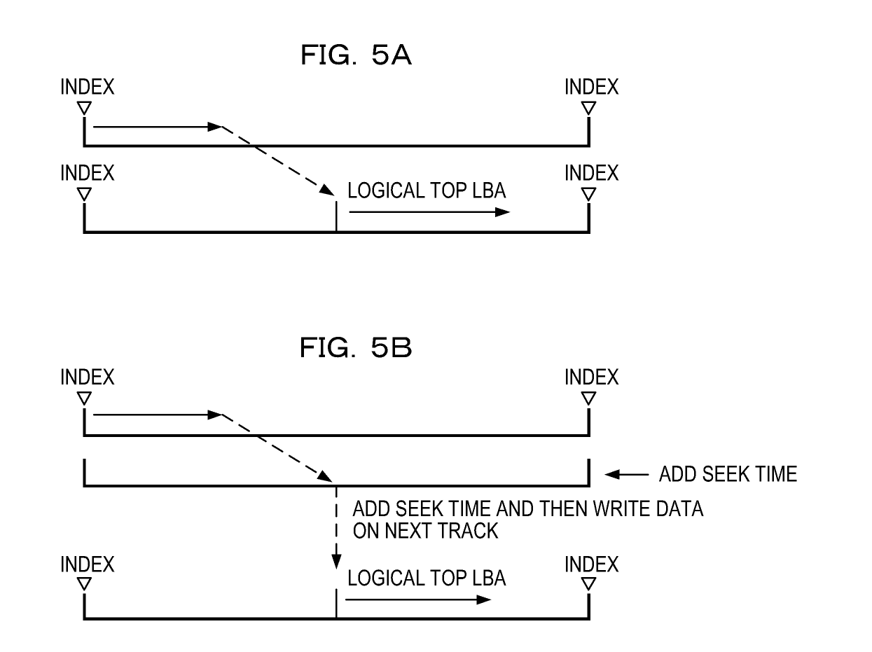

Here, the track changing process during which the seek time is added will be described with reference to FIGS. 5A and 5B. For comparison, FIG. 5A is the explanatory drawing of the track changing process of a comparative example and FIG. 5B is the explanatory drawing of the track changing process during which the seek time is added according to the first embodiment.

For the magnetic disk device of the comparative example, the head is moved to a track to be accessed next to write or read data successively without interval as illustrated in FIG. 5A, after data are written on or read from the track. While the head is moved, the magnetic disk medium is rotating. Therefore, a latency to reach a sector at a logical block addressing (LBA) address on which data are written or from which data are read (as illustrated with a dashed line with an arrow in FIG. 5A) is caused. The LBA address is a serial number through sectors of the magnetic disk media mounted in the magnetic disk device.

For HDD 1 according to the first embodiment, the seek time is added to slow the transfer rate by rotating magnetic disk medium 13 one revolution when the head is moved to the other track after the number of track changes reaches the reference value, as illustrated in FIG. 5B. Then data are successively written on or read from a track to be accessed next.

In the case described above, the transfer rate is slowed by adding the seek time when the number of track changes reaches the reference value regardless of where the track to be accessed is situated on magnetic disk medium 13. However, the transfer rates may differ depending on the areas accessed on magnetic disk medium 13. Next, a method for writing data on or reading data from magnetic disk medium 13 whose storage area is divided by logical block will be described.

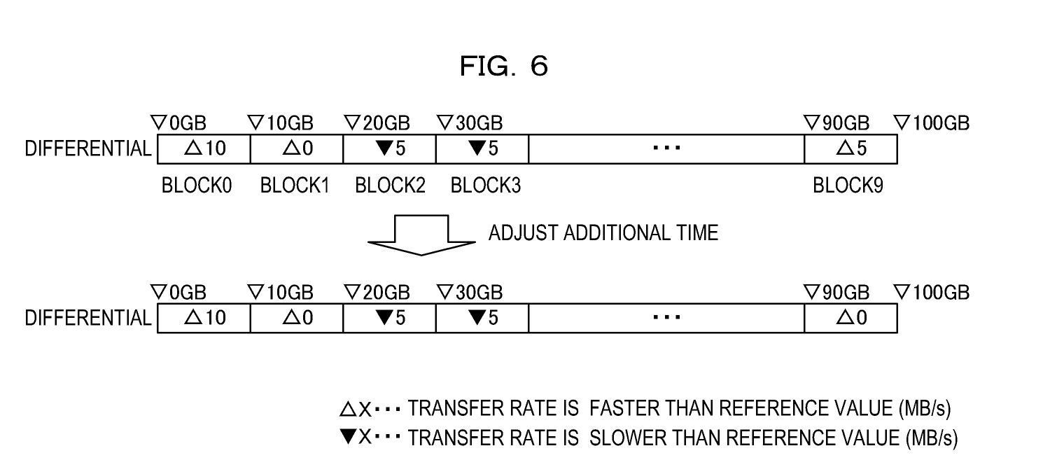

As the schematic diagram illustrated in FIG. 6 illustrates, a total capacity of the storage area of HDD 1 is 100 GB and the storage area is divided by 10 GB-blocks. In this case, a transfer rate (MB/s) of each block is derived. If there are blocks whose transfer rates are faster than the reference transfer rate (e.g., blocks 0 and 9), only the transfer rates of the blocks are adjusted by determining the reference value of the number of track changes.

The reference number of track changes is determined for each block as described above. More specifically, the reference value of the numbers of track changes of the blocks whose transfer rates are faster than the reference transfer rate (e.g., blocks 0 and 9) are determined respectively by deriving in the order of: time needed for accessing throughout the block successively (i.e., successive access time); a differential of the successive access time between drives (i.e., drive A and drive B; an additional time per track (ΔT); and the number of cylinders to be rotated in the rotational delay. Correspondence relationships between the determined reference value of the number of track changes and the blocks whose transfer rate are needed to be slowed are preconfigured in memory 9.

HDD 1 applies the process illustrated in the flow chart in FIG. 4 when data are successively written on or read from the block whose transfer rate is needed to be slowed. Thus, only the transfer rates of the blocks that are faster than the reference transfer rate (e.g., blocks 0 and 9) are approximated to the transfer rate of the reference drive.

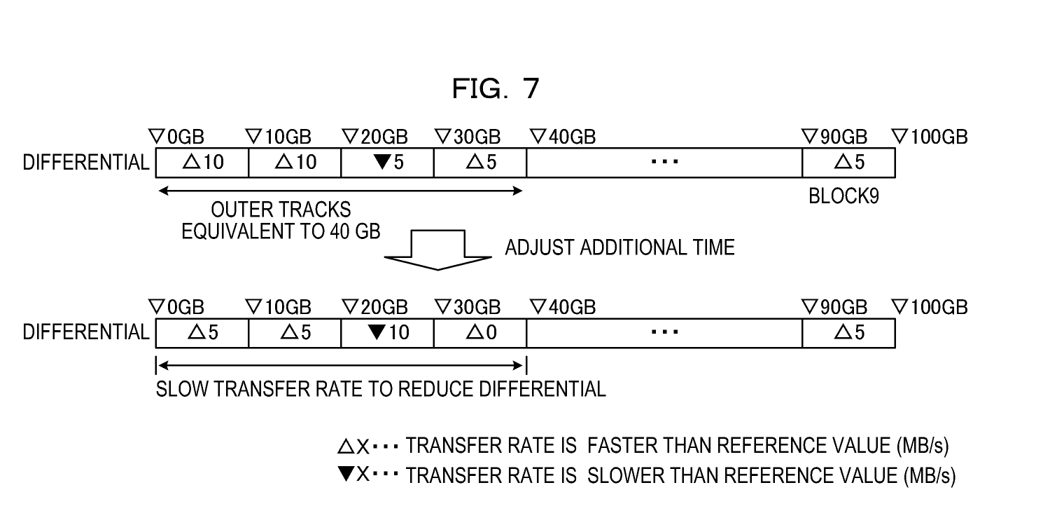

Generally, transfer rates of outer tracks of magnetic disk media are faster than those of inner tracks. FIG. 7 illustrates an example of HDD1 whose capacity is 100 GB. Where tracks equivalent to 40 GB from the outer most track of magnetic disk medium 13 are defined as outer tracks, the additional time is added to transfer rates of all outer tracks uniformly to slow the transfer rates.

As described above, the reference value of the number of track changes may be determined to control only the transfer rate of the outer tracks with the method described above. More specifically, the reference value of the number of track changes is determined by deriving data in the order of: the time needed for accessing throughout the outer tracks successively (i.e., the successive access time); the differential of the successive access time between drive A and drive B; the additional time per outer track (ΔT); and the number of cylinders to be rotated in the rotational delay.

HDD 1 applies the process illustrated in the flow chart in FIG. 4 to only the outer tracks. Therefore, only the transfer rates of the outer tracks may be adjusted as illustrated in FIG. 7.

In the first embodiment, the transfer rates are adjusted by adding the seek time to slow the transfer rate on changing a track after a predefined number of tracks are changed. In the second embodiment, the transfer rate is adjusted by adding the additional time by sector as an overhead, i.e., process time.

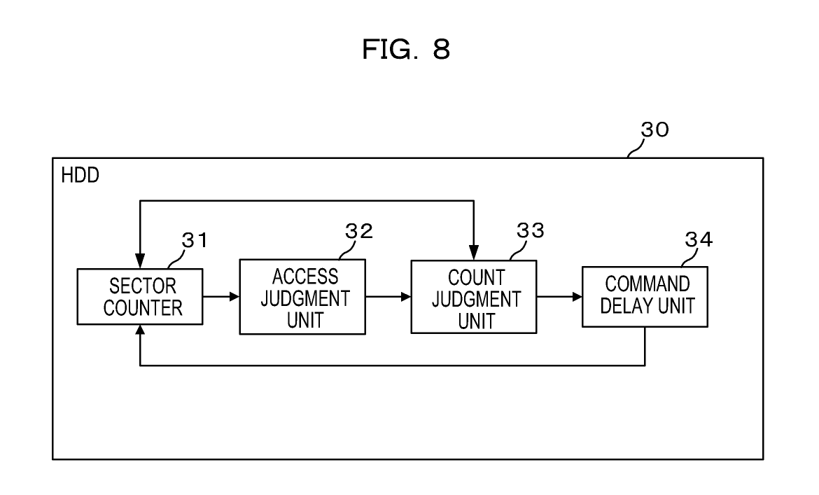

FIG. 8 is the functional block diagram of the magnetic disk device according to the second embodiment of the present technique. A magnetic disk device according to the second embodiment, HDD 30, has sector counter 31, access judgment unit 32, count judgment unit 33 and command delay unit 34. A structure of the hardware is the same as the structure in the first embodiment here. Therefore, a description of the hardware's structure is omitted (refer to FIG. 1).

Sector counter 31 counts the number of sectors of magnetic disk medium 13 (i.e., a storage medium) mounted in HDD 30 on which data are written or from which data are read in accessing magnetic disk medium 13 mounted in HDD 30.

Access judgment unit 32 judges whether data are written or read successively as in the access judgment unit 22 in the first embodiment does.

Count judgment unit 33 judges whether the number of counts counted by sector counter 31 has reached a reference value (i.e., a predefined number of times) when access judgment unit 32 judges that data are written or read successively.

Command delay unit 34 receives a command for writing or reading and slows the transfer rate by adding the additional time (i.e., the overhead). The access command is a command for writing or reading issued by host 100 to HDD 30, on which data are written on or read from magnetic disk medium 13, and a result of the command is reported to host 100. The additional time may be added before starting transfer data, in transferring the data, or before reporting a status. Alternatively, the additional time is added several times, i.e., before starting to transfer the data, in transferring the data and before reporting the status.

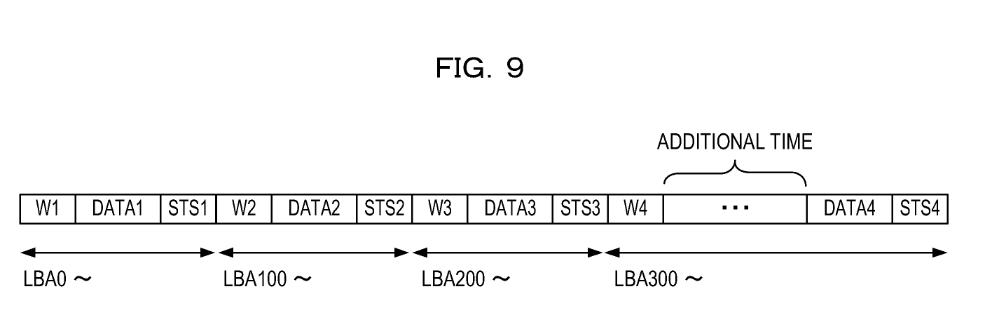

Next, a method for adding the additional time when HDD 30 receives the command for writing from host 100 will be disclosed with reference to FIG. 9.

FIG. 9 illustrates the example when HDD 30 processes data sent from host 100 in 100 sector increments. Wx represents the time when HDD 30 receives the command for writing sent from host 100. Data x represents the time when the data are transferred from host 100 and written on magnetic disk medium 13. Sts x represents the time when the result of the command for writing is reported. “x” represents a sequential number. The horizontal axis represents a time axis.

The writing process is executed in units of 100 sectors (i.e., a sector at LBA address 0 through LBA address 99, or LBA address 100 through LBA address 199) on a set of Wx, Data x and Sts x commands (hereinafter referred to as a Wx command.)

Where a reference number of sectors is 300 (i.e., the additional time is added by 300 sectors), the writing processes on commands W1 through W3 are executed without adding the additional time. A predefined additional time is added before starting to transfer data on W4 command (i.e., between W4 and Data 4 as illustrated in FIG. 9).

FIG. 9 illustrates that the additional time is added before starting to transfer the data. However, the additional time may be added in transferring the data (a processing time of data 4 is increased) or before reporting the status (between Data 4 and Sts 4).

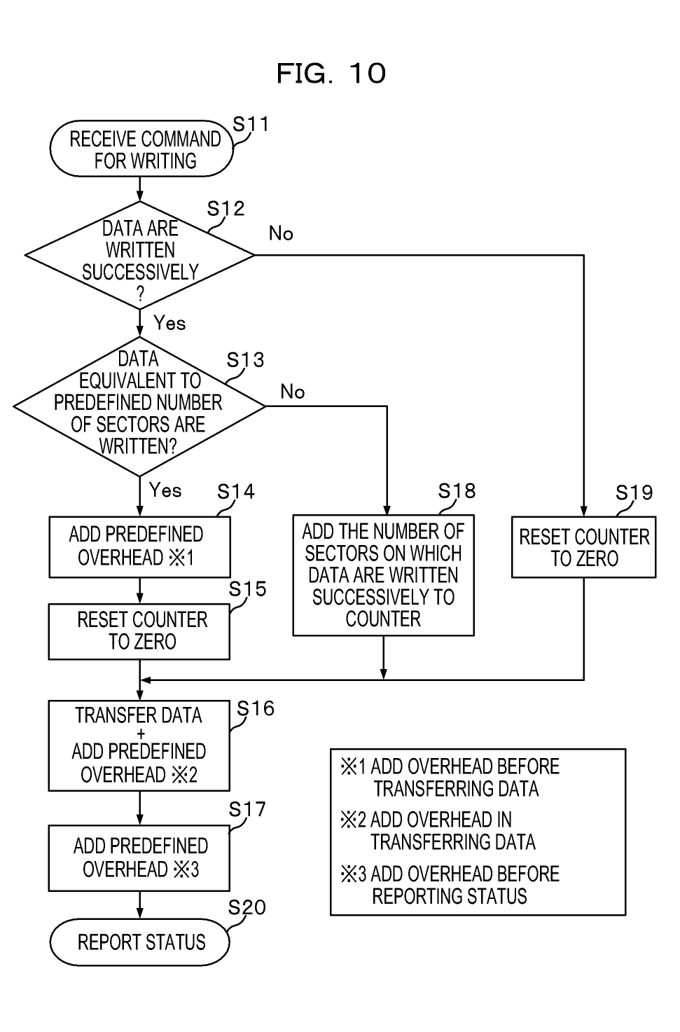

Next, the writing process executed by HDD 30 according to the second embodiment will be disclosed with reference to the flow chart illustrated in FIG. 10.

When the command for writing is received in step S11, access judgment unit 32 judges whether data are written successively (i.e., a sequence of processes in which data are transferred in a unit of a file between host 100 and magnetic disk medium 13 mounted in HDD 1 by the OS in the first embodiment) in step S12. If access judgment unit 32 judges that the data are written successively (step S12, Yes), access judgment unit 32 judges whether the number of sectors on which data are written has reached the predefined value or the reference value (i.e., the data written on the sector equivalent to the predefined number of sectors are transferred to host 100) in step S13. The number of the sectors on which the data are written is counted by sector counter 31 from where the successive writing started.

If sector counter 31 judges that the number of sectors on which the data are written reached the predefined value, i.e., the reference (S13, Yes), command delay unit 34 delays processing of the command for writing by adding the predefined additional time (i.e., the overhead) in step S14. Likewise in the first embodiment, the predefined value of the number of sectors on which data are written and the additional time may be determined to reduce the differential of the transfer rates (MB/s) between HDDs 30 connected with host 100. A method to determine the predefined value and the additional time will be disclosed later.

After the transfer rate is slowed by command delay unit 341, sector counter 31 resets the count to zero in step S15. Then data are transferred to magnetic disk medium 13 in step S16. Where the overhead is added during transferring data, command delay unit 34 adds the additional time (i.e., the overhead) and transfers the data in step S16. Where the overhead is added before reporting the status, command delay unit 34 adds the predefined additional time (i.e., the overhead) in step S17. The additional time is added in any of steps S14, S16 and S17 as necessary. The predefined additional time is not added in the steps during which the adding process is not needed.

Then the status is reported to host 100 in step S20.

If the data are not written successively (step S12, No), sector counter 31 resets the count to zero in step S19. If the number of the sectors on which the data are written does not reach the predefined value, i.e., the reference value (step S13, No), sector counter 31 adds the number of sectors on which the data are written on the command for writing to the count in step S18.

HDD 30 according to the second embodiment executes the sequence of steps S11 through S20 every time a command for writing is received.

Here, how to determine the reference number of sectors on which data are written and the additional time will be described. An explanation will be made with reference to drive A (with the transfer rate: 46,126,126 byte/s) and drive B (with the transfer rate: 50,738,738 byte/s) illustrated in FIGS. 3A and 3B as an example. A method for determining the reference value and the additional time to approximate the transfer rate of drive B to the transfer rate of drive A will be described.

A differential between the transfer rates is given by

50,738,738 byte/s−46,126,126 byte/s=4,612,612 byte/s

Where the differential is replaced with a unit of sector

4,612,612 byte/s÷512 bytes=9,009 Sct/s=9 Sct/ms

Therefore, the transfer rate of drive B is slowed 1 ms by 9 sectors to approximate the transfer rate of drive A.

Where the differential is replaced with a range of sectors on which data are written on a single command, the transfer rate of drive B is approximated to the predefined transfer rate (in this case, the transfer rate approximated to the transfer rate of drive A) by configuring values of the reference value and the additional time stored in memory 9 of drive B (i.e., HDD 30) to 900 and 100 ms respectively.

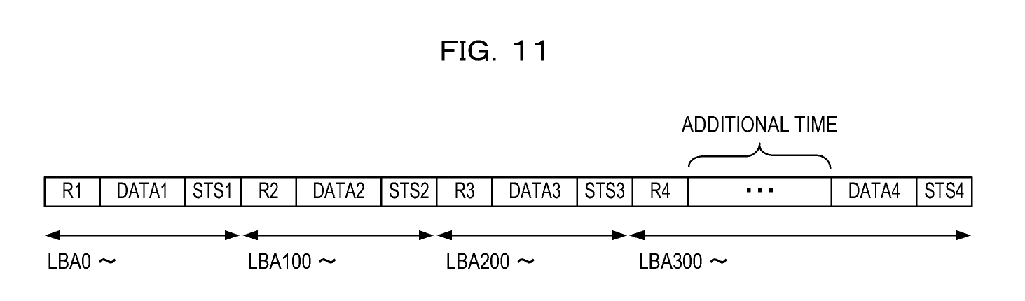

Next, a method for adding the additional time when HDD 30 according to the second embodiment receives a command for reading sent from host 100 will be disclosed with reference to FIG. 11.

FIG. 11 illustrates an example when HDD 30 reads data in a unit of 100 sectors on the command for reading sent from host 100. Rx represents the time when HDD 30 receives the command for reading sent from host 100 as well as in the writing process illustrated in FIG. 9. Data x represents the time when data are read from magnetic disk medium 13 and transferred to host 100. Sts x represents the time when a result of the command for reading is reported. “x” represents a sequential number. A horizontal axis represents a time axis.

The reading process is executed in units of 100 sectors (e.g., sectors at LBA addresses 0 through 99, or 100 through 199) on a set of commands Rx, Data x, and Sts x (hereinafter referred to as a Rx command).

Where the reference value of the number of sectors is 300 (i.e., the additional time is added every 300 sectors), the reading processes on commands R1 through R3 are executed without adding the additional time. A predefined additional time is added before starting to transfer data on the R4 command (between R4 and Data 4 as illustrated in FIG. 11).

FIG. 11 illustrates that the additional time is added before starting to transfer the data. However, the additional time may be added in transferring the data (a processing time of data 4 is increased) or before reporting a status (between Data 4 and Sts 4 as illustrated in FIG. 11).

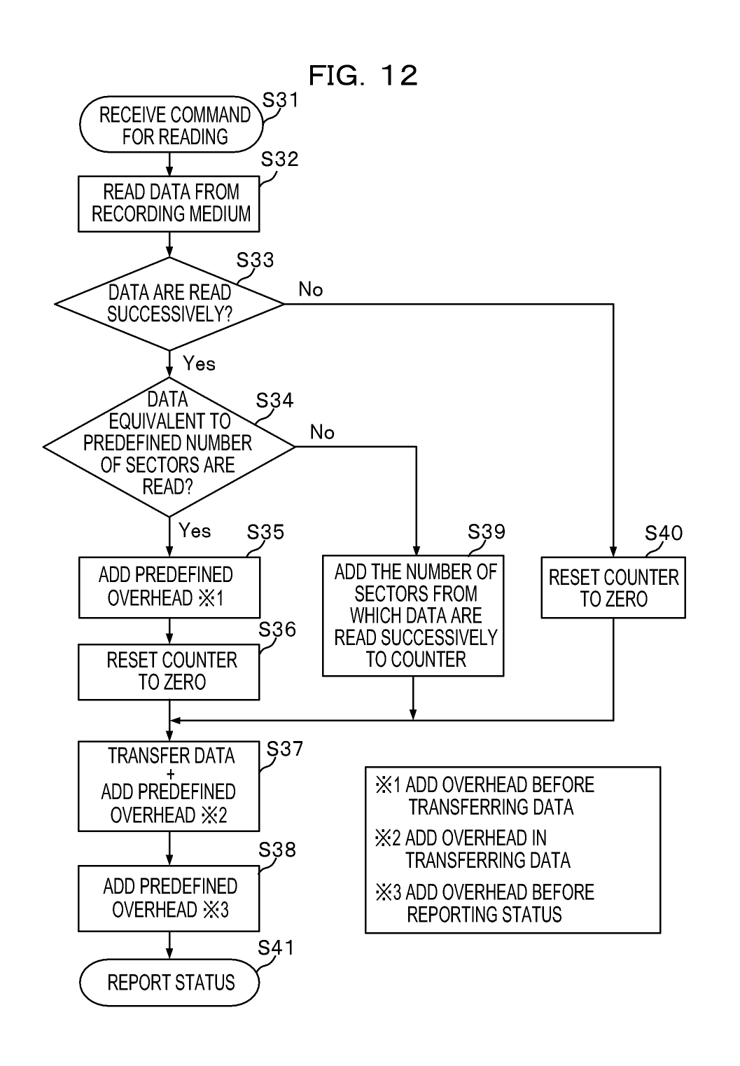

Next, the reading process executed by HDD 30 according to the second embodiment will be disclosed with reference to the flow chart illustrated in FIG. 12.

When HDD 30 receives the command for reading sent from host 100 in step S31, data are read from magnetic disk medium 13 in step S32. Steps S33 through S41 are the same as steps S12 through S20 illustrated for the writing process illustrated in FIG. 10 except data are read or written. A method for determining the reference value and the additional time is the same as the method for determining the reference value and the additional time applied in the writing process.

Accordingly, if magnetic disk devices with different transfer rates are used, the variation of the transfer rates may be reduced by adjusting the faster transfer rate to the slower transfer rate as described above. Thus, the performances of the magnetic disk devices are not much different when measured by the performance measurement tool.

As the comparative example, the magnetic disk devices are screened based on a certain range of performance before shipping. Meanwhile, in the embodiments of the present technique, the firmware judges the performance of each magnetic disk devices automatically and screens the magnetic disk device. Therefore, the inspection before shipping may be simplified and the differential of the performances between the magnetic disk devices to be shipped are reduced.

The method of the comparative example adjusts the differential of the performances between the magnetic disk devices by increasing the skew value. Meanwhile, the magnetic disk devices according to the embodiments of the present technique may adjust the differential of the performances between the magnetic disk devices by slowing the transfer rates only when the magnetic disk medium is accessed successively. There is no influence on the random access because it adds the overhead only at the sequential access pattern. Therefore, the performance of the magnetic disk device is not decreased when the magnetic disk medium is accessed randomly.

As described above, multiple magnetic disk devices are connected with host 100, and the faster transfer rates of the magnetic disk devices are adjusted to the slower transfer rate of other magnetic disk device in the embodiments of the present technique. For HDD 1 according to the first embodiment of the present technique, the transfer rates may be slowed to be approximated to any of the other transfer rates. More specifically, the transfer rate may be approximated to any of the slower transfer rates by adjusting the reference value of the number of track changes and the number of rotational delays added when the number of track changes reaches the reference value (one rotational delay is added in the first embodiment), respectively. (First, the reference value of track changes is determined. Then the number of the rotational delays is determined based on the reference value of the track changes.) In the second embodiment of the present technique, the transfer rate is approximated to any of the slower transfer rates by adjusting the reference value of the number of sectors on which data are written or from which data are read and the additional time, respectively.

Accordingly, this technique may control the transfer rate between the magnetic disk device and the host to the slower transfer rate.

All examples and conditional language recited herein are intended for pedagogical purposes to aid the reader in understanding the invention and the concepts contributed by the inventor to furthering the art, and are to be constructed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A storage device including a mechanism for driving a recording medium, comprising:
an access counter that counts the number of track changes or the number of accessed sectors in accessing the recording medium;
an access judgment unit that judges whether the recording medium is being accessed successively by a host;
a count judgment unit that judges whether a count counted by the access counter has reached a predefined number of times when the access judgment unit judges that the recording medium is being accessed successively; and
an access delay unit that delays the access to the recording medium so that a transfer rate between the storage device and the host is adjusted to a predefined transfer rate when the count judgment unit judges that the number of the count has reached the predefined number of times.

2. The storage device according to claim 1,
wherein the access delay unit executes seek operations for the recording medium according to the predefined number of times and delays the access by adding time needed for the seek operations to the access processing time.

3. The storage device according to claim 1,
wherein the count judgment unit judges that a value calculated based on a differential between the time needed for accessing throughout a storage area of the recording medium mounted in the storage device successively and the time needed for accessing throughout a storage area of a recording medium mounted in a reference storage device successively as the predefined number of times.

4. The storage device according to claim 1,
wherein the recording medium is divided into a plurality of logical blocks;
wherein the access counter counts the number of track changes in a selected logical block;
the access judgment unit judges whether the recording medium has been accessed successively by the logical block;
the count judgment unit judges whether the count counted in the logical block by the access counter has reached the predefined number of times; and
the access delay unit delays the access to the logical block.

5. A control method for a storage device including a mechanism for driving a recording medium, the control method comprising:
counting the number of track changes or the number of accessed sectors in accessing the recording medium;
judging whether the recording medium has been accessed successively by a host;
judging whether the count counted in the counting operation has reached a predefined number of times when the recording medium has been accessed successively; and
delaying access by adjusting a transfer rate between the storage device and the host so that a transfer rate between the storage device and the host is adjusted to a predefined transfer rate when the count reaches the predefined number of times.

6. The control method for the storage device according to claim 5,
wherein the access delaying operation includes executing seek operation for the recording medium the predefined number of times, and delaying the access by adding the time needed for the seek operations to the process time for accessing.

7. The control method for the storage device according to claim 5,
wherein the count judging operation includes judging a value calculated based on a differential between the time needed for accessing throughout a storage area of the recording medium mounted in the storage device successively and the time needed for accessing throughout a storage area of a recording medium mounted in other comparative storage devices successively as the predefined number of times.

8. The control method for the storage device according to claim 5,
wherein the counting operation includes counting the number of track changes in terms of logical blocks;
the access judging operation includes judging whether the recording medium is accessed successively in the logical blocks;
the count judging operation includes judging whether the count counted by the logical blocks in the counting has reached a predefined number of times; and
the access delaying operation includes delaying the access in the logical blocks.
